(19) United States
(12) Patent Application Publication
(10) Pub. No.: US 2025/0093041 A1
(43) Pub. Date: Mar. 20, 2025

(54) REMOVABLE MULTI-ZONE GRIDDLE FOR A COOKTOP APPLIANCE

(71) Applicant: Haier US Appliance Solutions, Inc., Wilmington, DE (US)

(72) Inventors: Omar Santana, Louisville, KY (US); Paul Bryan Cadima, Crestwood, KY (US)

(21) Appl. No.: 18/469,803

(22) Filed: Sep. 19, 2023

(51) Int. Cl. F24C 3/12; F24C 3/00; G05D 23/19

(52) U.S. Cl. CPC F24C 3/126; F24C 3/008; G05D 23/1934

(57) ABSTRACT

A cooktop includes a plurality of heating elements, a griddle removably positioned over the plurality of heating elements, the griddle defining a first heating zone and a second heating zone, a temperature sensing assembly operably coupled to the griddle for monitoring a first zone temperature of the first heating zone and a second zone temperature of the second heating zone, and a controller in operative communication with the plurality of heating elements and the temperature sensing assembly. The controller is configured to receive a request to perform a griddle cooking operation, the request comprising a first target temperature and a second target temperature, obtain the first zone temperature and the second zone temperature using the temperature sensing assembly, and operate the plurality of heating elements to drive the first zone temperature to the first target temperature and the second zone temperature to the second target temperature.

### FIELD OF THE INVENTION

The present subject matter relates generally to gas cooktops, and more particularly, to removable griddle assemblies that include multiple heating zones for use in gas cooktops.

### BACKGROUND OF THE INVENTION

Conventional gas cooktop appliances have one or more gas burners, e.g., positioned at a cooktop surface for use in heating or cooking an object, such as a cooking utensil and its contents. These gas burners typically combust a mixture of gaseous fuel and air to generate heat for cooking. These gas cooktops may include a grate or other support structure for receiving various cooking utensils, such as a griddle. For example, griddles may be positioned on the grate of the gas cooktop and may extend across multiple gas burners to provide a large, flat cooking surface.

Conventional cooktops including griddles typically operate using a simple open-loop power control system where users can select the desired power applied to the heating elements to indirectly achieve a cooking temperature. This method, however, may not provide precise temperature control. Accordingly, it may be desirable to facilitate a closed-loop cooking cycle with removable cooking utensils such as a griddle, e.g., by monitoring the temperature of the griddle and adjusting the gas burners to maintain the desired griddle temperature. Notably, it may also be desirable to facilitate removal of the griddle and operation of the heating elements in a traditional mode.

However, even if a cooktop could facilitate closed-loop cooking, only one type of food could be cooked at a time or multiple foods that require the same cooking temperature. This may be frustrating for users, especially when cooking different foods, e.g., such as in scenarios like breakfast, where different items may need to be cooked at different temperatures. For example, using conventional cooktops, if a user would like to make fried eggs (e.g., at 250° F.) and pancakes (e.g., at 375° F.), they would have to cook one food type at a time, causing the first cooked items to go cold before they are served.

Accordingly, gas cooktop appliances having a removable griddle with improved cooking control would be useful. More specifically, a gas cooktop that facilitates multi-zone griddle cooking would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a cooktop defining a vertical direction, a lateral direction, and a transverse direction is provided. The cooktop includes a plurality of heating elements, a griddle removably positioned over the plurality of heating elements, the griddle defining a first heating zone and a second heating zone, a temperature sensing assembly operably coupled to the griddle for monitoring a first zone temperature of the first heating zone and a second zone temperature of the second heating zone, and a controller in operative communication with the plurality of heating elements and the temperature sensing assembly. The controller is configured to receive a request to perform a griddle cooking operation, the request comprising a first target temperature and a second target temperature, obtain the first zone temperature and the second zone temperature using the temperature sensing assembly, and operate the plurality of heating elements to drive the first zone temperature to the first target temperature and the second zone temperature to the second target temperature.

In another exemplary embodiment, a method of operating a cooktop is provided. The cooktop includes a plurality of heating elements, a griddle removably positioned over the plurality of heating elements, the griddle defining a first heating zone and a second heating zone, and a temperature sensing assembly operably coupled to the griddle for monitoring a first zone temperature of the first heating zone and a second zone temperature of the second heating zone. The method includes receiving a request to perform a griddle cooking operation, the request comprising a first target temperature and a second target temperature, obtaining the first zone temperature and the second zone temperature using the temperature sensing assembly, and operating the plurality of heating elements to drive the first zone temperature to the first target temperature and the second zone temperature to the second target temperature.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a gas cooktop according to an example embodiment of the present subject matter.

FIG. 2 illustrates the example gas cooktop of FIG. 1 including a griddle assembly according to example embodiments of the present subject matter.

FIG. 3 provides a partial phantom view of the example griddle assembly of FIG. 2 to reveal a temperature sensing assembly according to example embodiments of the present subject matter.

FIG. 4 provides a schematic view of a control knob sequence to facilitate control of the example griddle assembly of FIG. 2 according to example embodiments of the present subject matter.

FIG. 5 is a method of operating a cooktop appliance according to an exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

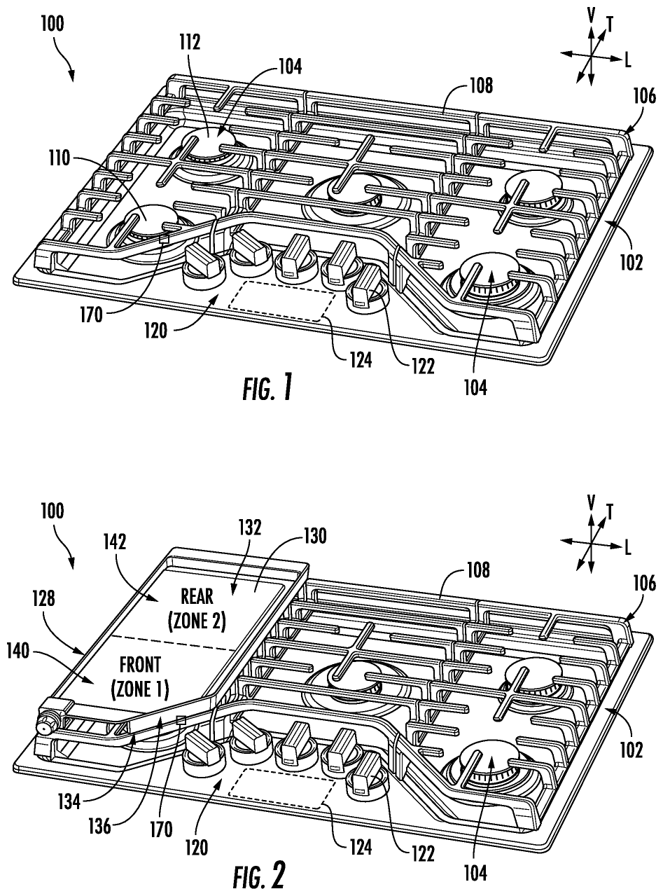

FIG. 1 illustrates an exemplary embodiment of a cooktop appliance, e.g., a gas cooktop 100, of the present disclosure. Gas cooktop 100 may be fitted integrally with a surface of a kitchen counter, may be configured as a slide-in cooktop unit, may be a part of a free-standing range cooking appliance, etc. Gas cooktop 100 may generally define a vertical direction V, a lateral direction L, and a transverse direction T, each of which is mutually perpendicular, such that an orthogonal coordinate system is generally defined. References to the horizontal direction or plane may refer generally to the plane defined by the lateral direction L and the transverse direction T.

Gas cooktop 100 includes a top panel 102 that includes one or more heating sources, such as heating elements 104 for use in, e.g., heating or cooking. Top panel 102, as used herein, refers to any upper surface of gas cooktop 100 over which utensils may be heated and therefore food cooked. In general, top panel 102 may be constructed of any suitably rigid and heat resistant material capable of supporting heating elements 104, cooking utensils, and/or other components of gas cooktop 100. By way of example, top panel 102 may be constructed of enameled steel, stainless steel, glass, ceramics, and combinations thereof.

According to the illustrated embodiment, the heating elements 104 of gas cooktop 100 are gas burners. However, although referred to as “gas cooktop” herein, it should be appreciated that aspects of the present subject matter may be applicable to other cooktop appliances, e.g., such as electrical resistance cooktops, inductive cooktops, etc. In addition, gas cooktop 100 may include one or more grates 106 configured to support a cooking utensil, such as a pot, pan, etc. In general, grates 106 include a plurality of elongated members 108, e.g., formed of cast metal, such as cast iron. The cooking utensil may be placed on the elongated members 108 of each grate 106 such that the cooking utensil rests on an upper surface of elongated members 108 during the cooking process. Heating elements 104 are positioned underneath the various grates 106 such that heating elements 104 provide thermal energy to cooking utensils above top panel 102 by combustion of fuel below the cooking utensils.

In some embodiments, the heating elements 104 of gas cooktop 100 may include a plurality of gas burners that are positioned on and/or within top panel 102 and have various sizes, as shown in FIG. 1, so as to provide for the receipt of cooking utensils (i.e., pots, pans, etc.) of various sizes and configurations and to provide different heat inputs for such cooking utensils. For example, the gas cooktop 100 may include a first gas burner 110 disposed on the top panel 102 and a second gas burner 112 spaced apart from the first gas burner 110 on the top panel 102. For example, as illustrated, the first gas burner 110 and the second gas burner 112 may be aligned along the transverse direction T. The top panel 102 may also include a recessed portion, e.g., which extends downward along the vertical direction V. The first gas burner 110 and the second gas burner 112 may be positioned within the recessed portion. The recessed portion may collect spilled material, e.g., foodstuffs, during operation of the gas cooktop 100.

In the illustrated example embodiments, each gas burner 110, 112 includes a generally circular shape from which a flame may be emitted. As shown, each gas burner 110, 112 includes a plurality of fuel ports defined circumferentially in fluid communication with an internal passage of each respective gas burner 110, 112. In some embodiments, one or both of the first gas burner 110 and the second gas burner 112 may be a multi-ring burner. For example, the first gas burner 110 may include a first plurality of fuel ports defining a first ring of the first gas burner 110 and a second plurality of fuel ports defining a second ring of the first gas burner 110. In such embodiments, a first fuel chamber in fluid communication with the first plurality of fuel ports may be separated from a second fuel chamber in fluid communication with the second plurality of fuel ports by a wall within the first gas burner 110, and fuel may be selectively supplied to one or both of the fuel chambers within first gas burner 110. In some embodiments of a cooktop appliance, multiple burners of differing types may be provided in combination, e.g., one or more single-ring burners as well as one or more multi-ring burners. Moreover, other suitable burner configurations are also possible.

According to the illustrated example embodiment, a user interface panel or control panel 120 is located within convenient reach of a user of gas cooktop 100. For this example embodiment, control panel 120 includes control knobs 122 that are each associated with one of heating elements 104. Control knobs 122 allow the user to activate each heating element 104 and regulate the amount of heat input each heating element 104 provides to a cooking utensil located thereon. Although gas cooktop 100 is illustrated as including control knobs 122 for controlling heating elements 104, it will be understood that control knobs 122 and the configuration of gas cooktop 100 shown in FIG. 1 is provided by way of example only. More specifically, control panel 120 may include various input components, such as one or more of a variety of touch-type controls, electrical, mechanical, or electro-mechanical input devices including rotary dials, push buttons, and touch pads.

According to the illustrated embodiment, control knobs 122 are located within control panel 120 of gas cooktop 100. However, it should be appreciated that this location is used only for the purpose of explanation, and that other locations and configurations of control panel 120 and control knobs 122 are possible and within the scope of the present subject matter. Indeed, according to alternative embodiments, control knobs 122 may instead be located directly on top panel 102 or elsewhere on gas cooktop 100, e.g., on a backsplash, front bezel, or any other suitable surface of gas cooktop 100. Control panel 120 may also be provided with one or more graphical display devices, such as a digital or analog display device designed to provide operational feedback to a user.

Referring again to FIG. 1, operation of the gas cooktop 100 may be regulated by a controller 124 that is operably coupled to (i.e., in operative communication with) the user inputs (e.g., control knobs 122) and/or heating elements 104. In this regard, control panel 120, control knobs 122, and other suitable inputs/outputs may be in communication with controller 124 such that controller 124 may regulate operation of gas cooktop 100. For example, signals generated by controller 124 may operate gas cooktop 100, including any or all system components, subsystems, or interconnected devices, in response to the position of control knobs 122 and other control commands. Control panel 120 and other components of gas cooktop 100 may be in communication with controller 124 via, for example, one or more signal lines or shared communication busses. In this manner, Input/Output (“I/O”) signals may be routed between controller 124 and various operational components of gas cooktop 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 124 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 124 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 124 may be operable to execute programming instructions or micro-control code associated with an operating cycle of gas cooktop 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 124 as disclosed herein is capable of and may be operable to perform any methods, method steps, or portions of methods as disclosed herein. For example, in some embodiments, methods disclosed herein may be embodied in programming instructions stored in the memory and executed by controller 124.

The memory devices may also store data that can be retrieved, manipulated, created, or stored by the one or more processors or portions of controller 124. The data can include, for instance, data to facilitate performance of methods described herein. The data can be stored locally (e.g., on controller 124) in one or more databases and/or may be split up so that the data is stored in multiple locations. In addition, or alternatively, the one or more database(s) can be connected to controller 124 through any suitable network(s), such as through a high bandwidth local area network (LAN) or wide area network (WAN). In this regard, for example, controller 124 may further include a communication module or interface that may be used to communicate with one or more other component(s) of gas cooktop 100, controller 124, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

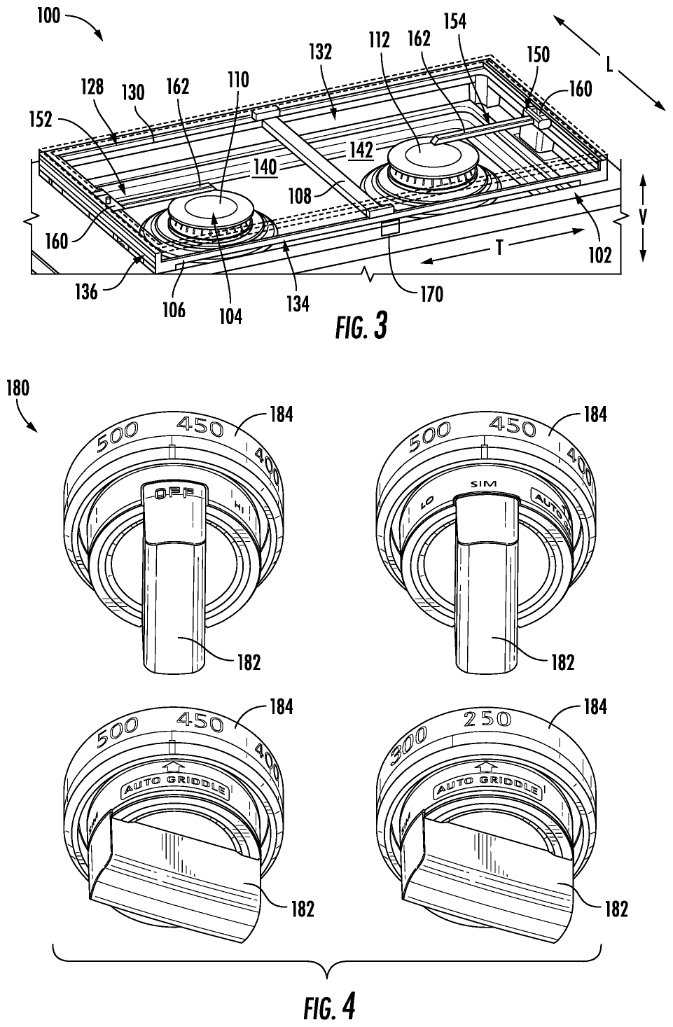

As shown in FIGS. 1 through 3, gas cooktop 100 may further include a griddle assembly 128 that may be installed on gas cooktop 100 as a cooking utensil. In general, griddle assembly 128 may include a griddle 130 that is selectively disposed over (e.g., directly above) one or more spaced-apart heating elements 104. For example, according to the illustrated embodiment, griddle 130 is positioned over a pair of burners, e.g., first gas burner 110 and second gas burner 112 to define a single, flat cooking surface selectively heated by gas burners 110, 112.

Specifically, during use, a top surface 132 of griddle 130 (i.e., a cooking surface) faces away from top panel 102 to receive a cooking item (e.g., food) thereon. By contrast, a bottom surface 134 may be opposite from top surface 132 and faces top panel 102 during use. Thus, the bottom surface 134 may face top panel 102 to receive a thermal output (e.g., flame or heated air) from the corresponding burners 110, 112. Although the present disclosure discusses the use of griddle 130 as the cooking utensil for use with gas cooktop 100, it should be appreciated that aspects of the present subject matter may apply to the use of other cooking utensils as well, e.g., such as a skillet, a pot, a pan, etc.

The bottom surface 134 of the griddle 130 may be supported by grate 106 when positioned on gas cooktop 100. For example, bottom surface 134 of the griddle 130 may be in contact with one or more elongated members 108 of grate 106, such as with a peripheral support surface and an intermediate support surface thereof. In addition, it should be appreciated that grate 106 and/or griddle 130 may define complementary features to facilitate proper positioning and alignment of griddle 130 on gas cooktop 100. In this regard, grate 106 may define engagement features (e.g., such as elongated members 108) and griddle 130 may define complementary features (e.g., such as a geometry of supporting feet). For example, as illustrated in the figures, griddle 130 may define an outer side 136, e.g., an outer perimeter of griddle 130 within a horizontal plane (e.g., defined by the lateral direction L and the transverse direction T). Outer side 136 may have a geometry or engagement features that are designed to engage griddle 130, such that the engagement features and the complementary features interact to secure the position of griddle 130. Grate 106 and griddle 130 may further define one or more protrusions and complementary detents, complementary ribs and grooves, etc. It should be appreciated that according to alternative example embodiments, griddle 130 can also be placed directly on top of top panel 102 without grate 106 being present.

Notably, it may be desirable to use griddle 130 to cook more than one type of food. In addition, it may be desirable to cook each food at a separate griddle temperature. Accordingly, aspects of the present subject matter are generally directed to a multi-zone cooktop and griddle assembly. Specifically, according to an example embodiment, griddle 130 defines a first heating zone 140 and a second heating zone 142. In general, first heating zone 140 and second heating zone 142 are different regions defined on top surface 132 of griddle 130 where different food items may be cooked and different temperatures may be maintained, as described in more detail below. Although two different cooking zones are described and illustrated herein, it should be appreciated that according to alternative embodiments, aspects of the present subject matter may include any other suitable number, size, geometry, and configuration of heating zones.

In addition, according to the illustrated embodiment, first gas burner 110 may generally be positioned below first heating zone 140 and second gas burner 112 may generally be positioned below second heating zone 142, e.g., to heat each zone respectively. However, it should be appreciated that more than two heating elements 104 may be used to collectively heat one or both of first heating zone 140 and second heating zone 142. The specific heating zone configuration described herein is only intended to facilitate discussion of aspects of the present subject matter and is not intended to be limiting in any manner.

In some embodiments, gas cooktop 100 may be configured for closed-loop cooking. For example, controller 124 may be operable to receive a set temperature (such as from a user input of the gas cooktop 100 or wirelessly from a remote device such as a smartphone) and compare the set temperature to temperature measurements from one or more temperature sensors, such as a temperature sensor associated with a cooking utensil (such as griddle 130), to each gas burner 110, 112. Controller 124 may be further programmed to automatically adjust each burner, such as a fuel flow rate to each burner, based on the comparison of the corresponding temperature measurement to the set temperature.

Accordingly, in order to facilitate a closed-loop cooking process, gas cooktop 100 or griddle assembly 128 may include a temperature sensing assembly 150 for monitoring the temperature of griddle 130. For example, according to the illustrated embodiment, temperature sensing assembly 150 may generally include a first temperature sensor 152 that is configured to monitor a first zone temperature in first heating zone 140 and a second temperature sensor 154 that is configured to monitor a second zone temperature in second heating zone 142. According to the illustrated embodiment, first temperature sensor 152 and second temperature sensor 154 are embedded within their respective heating zones 140, 142, e.g., approximately at a middle of each zone. It should be appreciated that temperature sensors 152, 154 may be permanently fixed in griddle 130 or may be removable.

According to example embodiments, each temperature sensor 152, 154 may include a sensor housing 160 and a temperature probe 162 extending therefrom for receipt within griddle 130, as described in more detail below. In general, sensor housing 160 may be configured for docking with a communication port (not shown) on griddle 130 or top panel 102 for providing electrical communication between the temperature probe 162 and controller 124. According to still other embodiments, temperature sensors 152, 154 may be wireless, and sensor housing 160 may contain operating electronics and a wireless communication module, e.g., for communicating with controller 124 of gas cooktop 100. For example, the sensor housing 160 and temperature probe 162 may be formed as a single, hermetically sealed package.

As used herein, “temperature sensor” or the equivalent is intended to refer to any suitable type of temperature measuring system or device positioned at any suitable location for measuring the desired temperature. Thus, for example, temperature sensors 152, 154 may each be any suitable type of temperature sensor, such as a thermistor, a thermocouple, a resistance temperature detector, a semiconductor-based integrated circuit temperature sensor, etc. In addition, temperature sensors 152, 154 may be positioned at any suitable location and may output a signal, such as a voltage, to a controller that is proportional to and/or indicative of the temperature being measured. Although exemplary positioning of temperature sensors is described herein, it should be appreciated that gas cooktop may include any other suitable number, type, and position of temperature sensors according to alternative embodiments.

According to example embodiments, gas cooktop 100 may further include a griddle detection system 170 that is generally configured to determine whether griddle 130 is properly installed on top of grate 106. In this regard, controller 124 may be in operative communication with the griddle detection system 170 such that the presence of griddle 130 may be detected or monitored. As described in more detail below, the operation of gas cooktop 100 may vary depending on whether griddle 130 is present. It should be appreciated that the griddle detection system 170 may be any suitable switch, trigger, sensor, or other device that is intended to detect the proper positioning of griddle 130 on gas cooktop 100. According to still other embodiments, griddle detection system 170 may be integrated into sensor housing 160, e.g., such that proper electrical connection between temperature probe 162 and controller 124 may act as a griddle detection system 170. It should be appreciated that according to alternative example embodiments, griddle 130 can also be placed directly on top of top panel 102 without grate 106 being present.

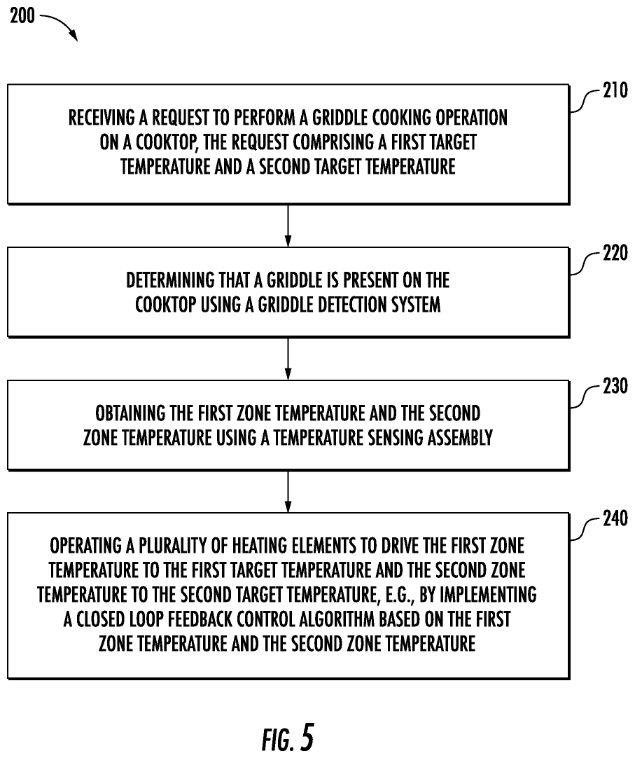

Referring now briefly to FIG. 4, gas cooktop 100 may further include one or more control knob assemblies 180 that are configured for regulating the heat output from each heating element 104, as described above. In this regard, control knob assemblies 180 may be the same or similar to control knobs 122 described above. Notably, control knob assemblies 180 may be generally configured for manually regulating the heat output of a respective heating element 104. This mode of operation may be referred to herein as the “manual” or “normal” mode of operation, which performs open-loop cooking with no temperature sensing. By contrast, control knob assemblies 180 may be used herein to place the gas cooktop 100 in a “griddle mode” of operation, which will be described in more detail below.

According to the illustrated embodiment, each control knob assembly 180 may generally include a manual valve 182 for manually regulating a heating level of a respective heating element 104. As illustrated, manual valve 182 may also be turned into a position where the “auto griddle mode” is activated. When auto griddle mode is activated, and griddle detection system 170 confirms the presence of griddle 130, the desired temperature for the particular zone of the griddle may be selected by manipulating encoder 184. In this regard, encoder 184 may be rotated to set a particular cooking temperature, e.g., in degrees Fahrenheit, or any other suitable manner of setting the heating level (e.g., on a scale of 1 to 10, or food type or cooking mode such as burger, toast, pancake, sear, etc.). For example, the top left control knob provides no heat because manual valve 182 is in the off position. The top right control knob has the manual valve turned to the simmer position, such that a simmering operation is performed. The bottom right control knob has the manual valve 182 turned to the auto griddle position and the temperature set at 250° F., such that closed-loop cooking on that respective heating zone is performed at 250° F. The bottom left control knob has the manual valve 182 turned to the auto griddle position and the temperature set at 460° F., such that closed-loop cooking on that respective heating zone is performed at 460° F.

Now that the construction and configuration of cooktop appliance 100 has been described according to exemplary embodiments of the present subject matter, an exemplary method 200 for operating cooktop appliance 100 will be described according to an exemplary embodiment of the present subject matter. Method 200 can be used to operate cooktop appliance 100, or may be used to operate any other suitable cooktop appliances. In this regard, for example, controller 124 may be configured for implementing some or all steps of method 200. Further, it should be appreciated that the exemplary method 200 is discussed herein only to describe exemplary aspects of the present subject matter and is not intended to be limiting.

Referring now to FIG. 5, method 200 includes, at step 210, receiving a request to perform a griddle cooking operation on a cooktop. For example, continuing the example from above, the user may manipulate control knob assemblies 180 to request a griddle cooking operation using griddle 130 of gas cooktop 100. Specifically, this request may include a multi-zone closed-loop cooking operation. Accordingly, the request may include a first target temperature (e.g., a target temperature for first heating zone 140) and a second target temperature (e.g., a target temperature for second heating zone 142). Although control knob assemblies 180 are described herein as being used to manipulate the closed-loop cooking process, it should be appreciated that any other suitable control interface may be used to perform this task, such as a touchscreen display, a software application on a user's mobile phone, etc.

According to example embodiments of the present subject matter, the first target temperature and the second target temperature may be the same if a user wishes to have a uniform cooking temperature across the entire top surface 132 of griddle 130. By contrast, if a user wishes to have separate heating zones at different temperatures, the first target temperature and the second target temperature may be separately selected and method 200 may include independently regulating each heating zone 140, 142. According to example embodiments, even when both of the selected temperatures are the same, the two temperatures may still have to be separately selected (both encoders 184 to the same temperature) and each zone may also be independently regulated by each sensor and burner (even though temperature setting is the same). It should be appreciated that the difference between the first target temperature and the second target temperature may be greater than 5° F., greater than 20° F., greater than 50° F., greater than 100° F., greater than 200° F., or greater. In addition, although two heating zones 140, 142 are described herein as being regulated to respective target temperatures, it should be appreciated that aspects of the present subject matter may be applicable to any other suitable number of heating zones.

As explained above, it may be desirable to ensure that griddle 130 is present before initiating a closed-loop cooking mode. Accordingly, step 220 may generally include determining that a griddle is present on a cooktop using a griddle detection system. In this regard, griddle detection system 170 may be used to determine that griddle 130 is properly positioned in place and that temperature sensing assembly 150 is properly communicating temperatures to controller 124, e.g., to facilitate the closed-loop cooking process.

Step 230 generally includes obtaining the first zone temperature and the second zone temperature using a temperature sensing assembly. In this regard, controller 124 may continuously or periodically monitor the temperature of first heating zone 140 and second heating zone 142 using first temperature sensor 152 and second temperature sensor 154, respectively. It should be appreciated that the frequency of temperature sampling may vary while remaining within the scope of the present subject matter.

Step 240 generally includes operating a plurality of heating elements to drive the first zone temperature to the first target temperature and a second zone temperature to the second target temperature. In this regard, step 240 may include implementing a closed-loop feedback control algorithm based on the measured first and second zone temperatures relative to the first and second zone target temperatures. According to example embodiments, the closed-loop feedback control algorithm may include the use of proportional (P), proportional-integral (PI), or proportional-integral-derivative (PID) control for feedback-based control implemented with, e.g., temperature feedback from one or more temperature sensors 152, 154. It should be appreciated that other suitable methods of performing closed-loop control are possible and within the scope of the present subject matter.

FIG. 5 depicts an exemplary control method having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 200 are explained using cooktop appliance 100 as an example, it should be appreciated that these methods may be applied to the operation of any suitable cooktop appliance capable of receiving a griddle.

As explained herein, aspects of the present subject matter are generally directed to a removable multi-zone griddle for cooking appliances (e.g., cooktops with electric or gas burners). The cooktop is configured to operate in traditional and griddle modes. In the traditional mode, the griddle is not used, and a round cookware may be used over individual heating elements (burners). In the griddle mode, the cooktop may be configured to recognize the presence of the griddle (when the griddle is placed on the cooktop). The cooktop may further allow a user to select the desired cooking temperature for each zone (e.g., using associated control knobs), which is controlled by the respective heating elements. Each zone may include a temperature sensor, e.g., to facilitate closed-loop control of zone temperatures independently from the other zones. A manual valve (knob) may be set to “Auto Griddle” to enable the griddle mode, and this may allow users to set the target temperature with an encoder. The griddle may either be used as a single zone maintaining a uniform temperature across entire surface or as a dual zone maintaining different temperatures across the surface of the griddle (e.g., within front and rear zones).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooktop defining a vertical direction, a lateral direction, and a transverse direction, the cooktop comprising:
a plurality of heating elements;
a griddle removably positioned over the plurality of heating elements, the griddle defining a first heating zone and a second heating zone;
a temperature sensing assembly operably coupled to the griddle for monitoring a first zone temperature of the first heating zone and a second zone temperature of the second heating zone; and
a controller in operative communication with the plurality of heating elements and the temperature sensing assembly, the controller being configured to:
receive a request to perform a griddle cooking operation, the request comprising a first target temperature and a second target temperature;
obtain the first zone temperature and the second zone temperature using the temperature sensing assembly; and
operate the plurality of heating elements to drive the first zone temperature to the first target temperature and the second zone temperature to the second target temperature.

2. The cooktop of claim 1, further comprising:
a griddle detection system, wherein the controller is configured to determine that the griddle is present on the cooktop using the griddle detection system before implementing the griddle cooking operation.

3. The cooktop of claim 1, wherein the temperature sensing assembly comprises:
a first temperature sensor embedded in the first heating zone of the griddle and a second temperature sensor embedded in the second heating zone of the griddle.

4. The cooktop of claim 3, wherein the first temperature sensor is positioned in a middle of the first heating zone and the second temperature sensor is positioned in a middle of the second heating zone.

5. The cooktop of claim 1, wherein operating the plurality of heating elements to drive the first zone temperature to the first target temperature and the second zone temperature to the second target temperature comprises:
implementing a closed-loop feedback control algorithm based on the first zone temperature and the second zone temperature.

6. The cooktop of claim 5, wherein the closed-loop feedback control algorithm comprises a proportional control algorithm, a proportional-integral control algorithm, or a proportional-integral-derivative control algorithm.

7. The cooktop of claim 1, wherein the griddle further defines a third heating zone, the temperature sensing assembly monitors a third zone temperature of the third heating zone, and the controller is further configured to:
receive a third target temperature;
obtain the third zone temperature using the temperature sensing assembly; and
operate the plurality of heating elements to drive the third zone temperature to the third target temperature.

8. The cooktop of claim 1, wherein the first target temperature and the second target temperature are different by greater than 100 degrees Fahrenheit.

9. The cooktop of claim 1, wherein the griddle cooking operation may operate to regulate the first target temperature and the second target temperature to a uniform temperature.

10. The cooktop of claim 1, wherein each of the plurality of heating elements are gas burners, the cooktop further comprising:
a grate positioned above the gas burners for supporting the griddle.

11. The cooktop of claim 1, further comprising a control knob assembly for regulating a first heating element of the plurality of heating elements, the first heating element being associated with the first heating zone of the griddle, the control knob assembly comprising:
a manual valve for manually regulating a heating level of the first heating element or placing the first heating element in a griddle mode; and
an encoder for selecting the first target temperature of first heating zone in the griddle mode.

12. A method of operating a cooktop, the cooktop comprising a plurality of heating elements, a griddle removably positioned over the plurality of heating elements, the griddle defining a first heating zone and a second heating zone, and a temperature sensing assembly operably coupled to the griddle for monitoring a first zone temperature of the first heating zone and a second zone temperature of the second heating zone, the method comprising:
receiving a request to perform a griddle cooking operation, the request comprising a first target temperature and a second target temperature;
obtaining the first zone temperature and the second zone temperature using the temperature sensing assembly; and
operating the plurality of heating elements to drive the first zone temperature to the first target temperature and the second zone temperature to the second target temperature.

13. The method of claim 12, wherein the cooktop further comprises a griddle detection system, the method further comprising:
determining that the griddle is present on the cooktop using the griddle detection system before implementing the griddle cooking operation.

14. The method of claim 12, wherein the temperature sensing assembly comprises:
a first temperature sensor embedded in the first heating zone of the griddle and a second temperature sensor embedded in the second heating zone of the griddle.

15. The method of claim 12, wherein operating the plurality of heating elements to drive the first zone temperature to the first target temperature and the second zone temperature to the second target temperature comprises:
implementing a closed-loop feedback control algorithm based on the first zone temperature and the second zone temperature.

16. The method of claim 15, wherein the closed-loop feedback control algorithm comprises a proportional control algorithm, a proportional-integral control algorithm, or a proportional-integral-derivative control algorithm.

17. The method of claim 12, wherein the griddle further defines a third heating zone, the temperature sensing assembly monitors a third zone temperature of the third heating zone, the method further comprising:
receiving a third target temperature;
obtaining the third zone temperature using the temperature sensing assembly; and
operating the plurality of heating elements to drive the third zone temperature to the third target temperature.

18. The method of claim 12, wherein the first target temperature and the second target temperature are different by greater than 100 degrees Fahrenheit.

19. The method of claim 12, wherein the griddle cooking operation may operate to regulate the first target temperature and the second target temperature to a uniform temperature.

20. The method of claim 12, the cooktop further comprising a control knob assembly for regulating a first heating element of the plurality of heating elements, the first heating element being associated with the first heating zone of the griddle, the control knob assembly comprising:
a manual valve for manually regulating a heating level of the first heating element or placing the first heating element in a griddle mode; and
an encoder for selecting the first target temperature of first heating zone in the griddle mode.
